(19) United States
(12) Patent Application Publication
(10) Pub. No.: US 2008/0291530 A1
(43) Pub. Date: Nov. 27, 2008

(54) Amplifying Medium Comprising a Liquid Medium Based on Halogenated Ligands and Lanthanides

(75) Inventors: Laurent Divay, Ivry-Sur-Seine (FR); Jean-Paul Pocholle, La Norville (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/097,705

(22) PCT Filed: Dec. 11, 2006
(86) PCT No.: PCT/EP06/69550

§ 371 Date: Jun. 16, 2008

(30) Foreign Application Priority Data
Dec. 16, 2005 (FR) 05 12841

(51) Int. Cl. H01S 3/207

(52) U.S. Cl. 359/342

(57) ABSTRACT

The invention relates to an optical amplifying medium comprising a liquid medium, having an organic ligand corresponding to the following chemical formula:

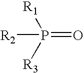

the groups R₁, R₂ and R₃ comprising halogenated chains and a rare earth ion. The advantage of using a liquid medium lies in the possibility of more easily discharging the heat within the amplifying medium. The present solution provides a formulation that furthermore makes it possible to have entities that are non-toxic contrary to those proposed in the prior art.

### CROSS-REFERENCE TO RELATED APPLICATIONS

The present Application is based on International Application No. PCT/EP2006/069550, filed on Dec. 11, 2006, which in turn corresponds to French Application No. 0512841 filed on Dec. 16, 2005, and priority is hereby claimed under 35 USC §119 based on these applications. Each of these applications are hereby incorporated by reference in their entirety into the present application.

### FIELD OF THE INVENTION

The field of the invention is that of rare-earth-doped amplifying laser mediums which may be used as an active medium in a laser system. Nowadays, the use of these materials as an amplifying medium allows the production of a high-intensity laser. Nevertheless, the solid state generates drawbacks linked to the problem of the dissipation of the heat produced within the amplifying medium and limits the volume of the amplifying medium and the intensity of the beam.

### BACKGROUND OF THE INVENTION

In parallel to studies carried out on solid power lasers, the discovery, already since the 1970s, of liquid systems that are solvent for lanthanides has made it possible to consider liquid amplifiers as an advantageous alternative to solid systems. This is because a liquid amplifying medium makes it possible to be free of problems inherent to the treatment of high-power laser pulses. The circulation of the liquid in the amplifier, which makes it possible to have a constantly renewed medium, protects the component from irreversible damage that is possibly caused by the high optical intensity. Moreover, the circulation of the fluid enables coupling to a circuit that ensures the cooling of the medium as described, in particular, in U.S. Pat. No. 6,600,766 and Patent Application US 2003/0206568.

Generally, the “direct” solvents for lanthanides are liquids based on phosphorous oxychloride acidified by a Lewis acid. The liquid obtained has an ionic character suitable for dissolving ions, in particular lanthanides.

These solvents are advantageous for the exploitation of the optical properties of lanthanides that are near-infrared emitters: their inorganic nature makes it possible to retain an emission lifetime that is long enough to obtain optical gain at reasonable pump powers. This is because the fluorescence lifetime is very sensitive to the presence of chemical groups that absorb in the near infrared such as the chemical bonds O—H, N—H, C—H and any bond having high-energy vibration harmonics (in the near IR).

The major obstacle preventing the development of this type of component is the instability and the toxicity of the solvent. This is because phosphorous oxychloride and related products are, on the one hand, extremely reactive in the presence of water (exothermic reaction) and, on the other hand, extremely toxic (can be fatal by inhalation, ingestion or contact with the skin). Furthermore, their corrosive nature limits the use of metals in contact with the solvent for applications such as the manufacture of circuits: gates, valves, etc.

There is currently no industrially viable alternative to the use of these compounds.

Other advantageous solvents potentially exist, especially fluorohydrocarbons which have suitable near-infrared transmission properties. They are, moreover, inert and are therefore not toxic. They are advantageous due to the opportunity that it provides to adjust their physicochemical properties (viscosity, boiling point, refractive index) by acting on the chain length or the composition (substitution of fluorine with bromine or other halogens). These are however apolar liquids, and the lanthanide ions are therefore not soluble therein in the salt form. It is therefore necessary to modify their surface in order to increase their solubility.

### SUMMARY OF THE INVENTION

In this context of researching materials for optical amplification that can be used in the liquid state, the Applicant has relied on entities of rare-earth organometallic complex type to provide novel amplifying media in the liquid state produced from complexes that comprise organic ligands and ionic compounds based on lanthanide.

More precisely, the subject of the present invention is an optical amplifying medium comprising a liquid medium, characterized in that said liquid medium comprises:
an organic ligand corresponding to the following chemical formula:

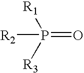

the groups R₁, R₂ and R₃ comprising halogenated chains; and
a rare earth ion.

According to one variant of the invention, the groups R₁ and/or R₂ and/or R₃ may additionally comprise deuterium atoms.

According to one variant of the invention, the liquid medium may additionally comprise an apolar solvent.

According to one variant of the invention, the ligand may act as a counterion to the rare-earth ion.

According to one variant of the invention, the liquid medium comprises a counterion dissociated from the ligand.

According to one variant of the invention, the ligand may correspond to the following chemical formula:

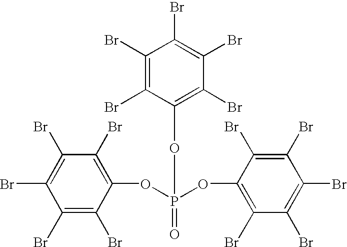

According to one variant of the invention, the ligand may correspond to the following chemical formula:

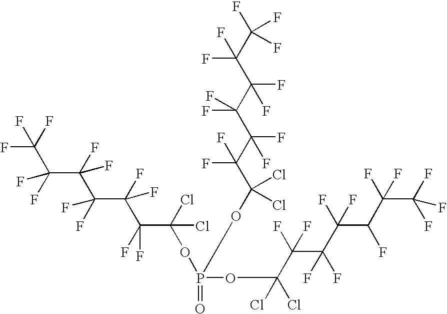

According to one variant of the invention, the ligand may correspond to the following chemical formula:

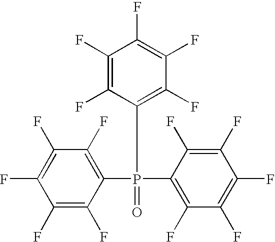

According to one variant of the invention, the rare-earth ion is Er³⁺

According to one variant of the invention, the counterion may be of halogen type or of organic type.

Thus, according to the invention, the complex formed between the ligand and the lanthanide entity may be of the type:

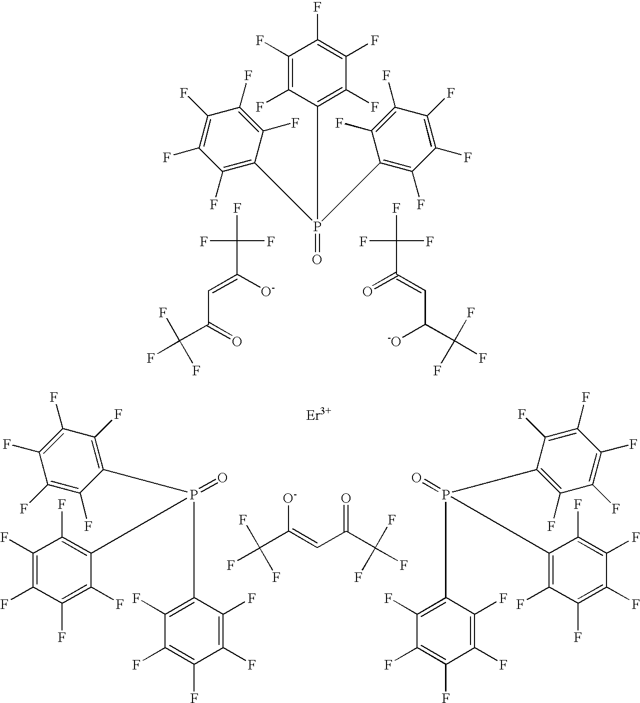

Advantageously, the solvent used may be of halogenated chain type comprising one type of halogen or a variety of halogens.

Typically, the solvent may be a compound of CₙX₂ₙ₊₁₋ᵢAᵢ type, X being a halogen, for example fluorine, A possibly being another halogen, for example chlorine, or another atom apart from hydrogen.

In particular, the use of halogenated solvents of the fluorocarbon or chlorofluorocarbon (CFC) type, or else any type of chlorinated solvents, on condition that they do not contain any hydrogen atoms, will be preferred.

According to one variant of the invention, the solvent is a compound of CₙF₂ᵢ₊₂A₂ⱼ₊₂ type, A being a halogen other than fluorine and i+j being equal to n.

Such compounds make it possible to vary the optical index of the solvent if need be, relative to the low index of a solvent of CₙF₂ₙ₊₂ type. This is because it may be necessary to adjust the index of the liquid amplifying medium in order to optimize the optical paths by reflection within said amplifying medium.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF DRAWINGS

The present invention is illustrated by way of example, and not by limitation, in the figures of the accompanying drawings, wherein elements having the same reference numeral designations represent like elements throughout and wherein:

FIG. 1 illustrates an example of the structure of an optical amplifier using a liquid amplifying medium according to the invention.

### DETAILED DESCRIPTION OF THE INVENTION

Generally, the liquid amplifying medium comprises ligands which may also and optionally act as counterions (the coordination number of the rare earths is very variable, the lanthanide-ligand bonds being mainly of electrostatic origin).

The organic ligand is chosen for its affinity with the lanthanide ion (it thus prevents the approach of molecules that inhibit the luminescence properties of the lanthanide, for example water). It has:
a P═O part which provides the ligand-rare earth bond; and
an organic part, which enables the solubilization, in a solvent, of the complex formed by the ligand-rare earth bond, and which increases its steric hindrance (it thus acts as a shield against inhibitory molecules). The organic part must be formulated to act as little as possible on the luminescence properties of the lanthanide, and to optionally make it possible to increase the solubility of the complex in a chosen solvent, if such a solvent is used, especially when the ligand/rare earth system is not liquid at the usage temperature.

The rare-earth ion chosen to form a complex with the ligand is chosen for its emission properties (emission wavelength and lifetime).

According to one variant of the invention, the ligand system may contain charged entities to counterbalance the charge of the rare earth, and (if necessary for saturation of the first coordination sphere) uncharged entities. The ions which counterbalance the charge of the lanthanide may be any type of ion or molecule (halogens, organic or inorganic ligands and counterions, including P═O ligands). In the case where the first coordination sphere is not saturated, or when the counterions do not ensure the high solubility of the complex in the solvent, it is possible to add neutral P═O ligands.

### EXAMPLE 1

### Synthesis of Phosphine Ligand 1

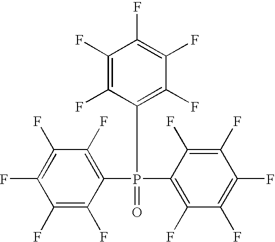

Added to a mixture of magnesium (2.51 g, 103.3 mmol) in anhydrous ether (15 ml) was a solution of bromopentafluorobenzene (12.6 ml, 101.2 mmol) in ether (35 ml). After stirring for one hour at a temperature close to 0° C., the solution was added to a solution of PCl₃ (phosphorous trichloride) (2.95 ml, 33.73 mmol) in ether (50 ml) and stirred for 1 h. The solution was then filtered and concentrated under vacuum. The product was purified by distillation.

Oxidation of the Phosphine:

1.75 g of phosphine were dissolved in 3 ml of toluene.

Added dropwise was a solution produced by adding 3.73 g of a solution of hydrogen peroxide (6%) in water to 2 ml of THF (tetrahydrofuran).

The mixture was stirred for 48 hours at ambient temperature.

The inhomogeneous mixture was decanted, and the toluene separated.

The aqueous phase was evaporated.

And the product was dried under vacuum.

Synthesis of the Complex 1

A solution of phosphine oxide in methanol was added to a solution of NdCl₃.6H₂O in excess in methanol.

The following complex:

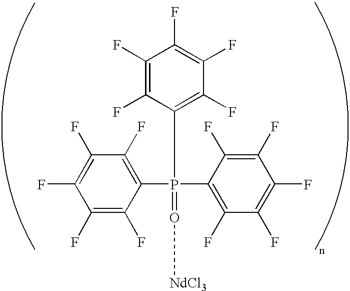

was separated by centrifuging, washed with methanol and dried under vacuum at 100° C.

It had three Cl⁻ counterions to compensate for the 3+ charge of the lanthanide, and enough organic ligands to saturate the first coordination sphere of the erbium ion.

The emission properties were characteristic of the Nd³⁺ ion (emission at 1.06 μm after excitation at 560 nm) and the emission lifetime in the solid state was equal to 60 μs.

### EXAMPLE 2

From the same phosphine ligand 1, it was proposed to form another complex with another type of organic counterions.

A solution of phosphine oxide 1 in methanol was added to a solution of Er(HFA)₃.6H₂O in excess in methanol. (HFA=hexafluoroacetylacetonate).

The following complex:

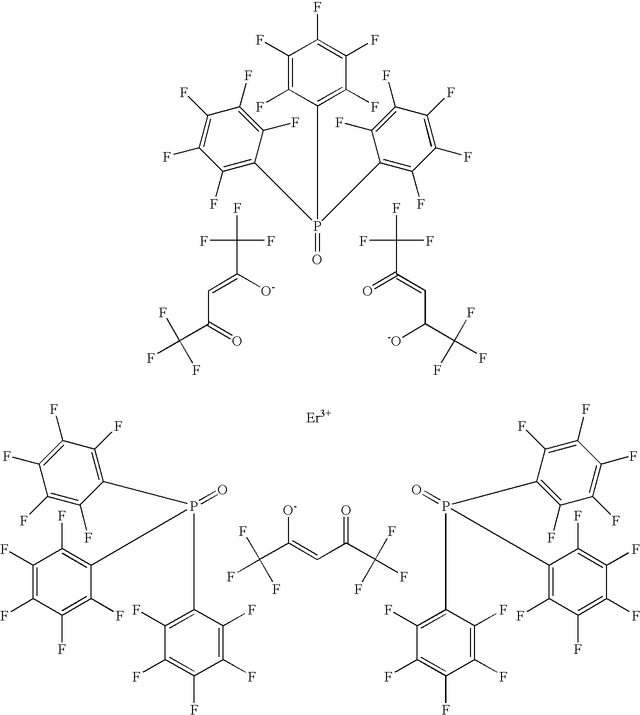

was precipitated, separated by centrifuging, washed with methanol and dried under vacuum at 100° C.

As for example 1, there were enough P═O ligands to saturate the first coordination sphere. The emission properties were characteristic of the erbium ion (emission at 1.53 μm after excitation at 520 nm) and the lifetime in the solid state was measured as equal to 170 μs.

### EXAMPLE 3

According to another variant of the invention, the P═O ligand may be the only ligand in the case where it provides the role of a counterion, as illustrated in the following example.

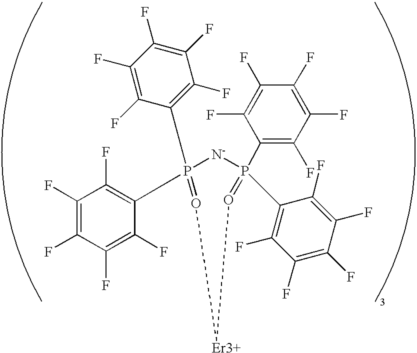

In this case, the counterion already completely saturates the first coordination sphere due to its steric hindrance and an additional neutral ligand is not necessary.

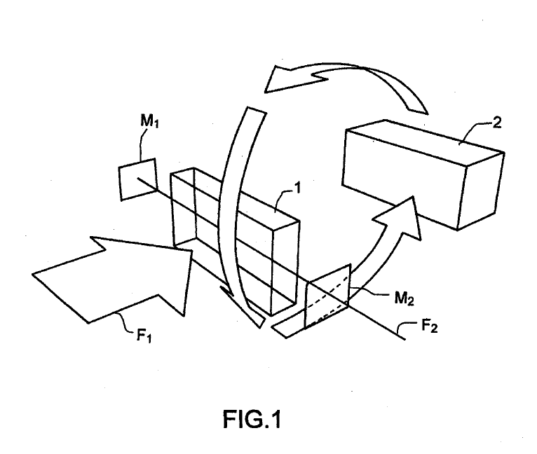

An example of the structure of an optical amplification device comprising a liquid amplifying medium according to the invention and as illustrated in FIG. 1 will be described below.

The device is composed of a chamber 1, comprising the previously described amplifying medium and located between two mirrors M₁ and M₂, the mirror M₁ advantageously having a maximum reflection coefficient at the operating wavelength of the laser, the mirror M₂ being partially transparent in order to release, from the laser cavity, the amplified laser beam F₂.

The medium may advantageously be optically pumped by means of laser diodes that deliver a pumping beam F₁. The system is sized so that the energy of the pump is absorbed in the thickness of the chamber.

The device additionally comprises a circulation/cooling system for the fluid 2.

Circulation of the Fluid:

The fluid circulates through the chamber using a pump system that is not shown, in the direction of the cooling system, as represented on the diagram by the transverse arrow. The circuit may be coupled, if necessary, to a system that allows control of the temperature of the fluid and/or its pressure.

Path of the Beam:

The laser beam passes through the amplifying medium. Its path may be maximized so as to improve the laser yield, for example by using multiple reflections on optical plates that serve as walls of the chamber.

Chamber:

The chamber may be treated with anti-reflection properties at the wavelength of the pump, so as to limit the energy losses through reflection of the optical pumping light.

Finally, the modular appearance may be emphasized, by multiplying the number of individual cells in the cavity with zigzag propagation of the laser mode.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1-13. (canceled)

14. An amplification device comprising a chamber comprising:
an optical amplifying medium comprising a liquid medium, placed between two mirrors (M₁, M₂), in which the liquid medium comprises:
an organic ligand corresponding to the following chemical formula: 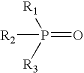
the groups R₁, R₂ and R₃ comprising halogenated chains; and
a rare earth ion.

15. The amplification device as claimed in claim 14, wherein certain halogenated groups additionally comprise deuterium atoms.

16. The amplification device as claimed in claim 14, wherein the liquid medium additionally comprises an apolar solvent.

17. The amplification device as claimed in claim 14, wherein the ligand comprises a counterion function to the rare earth ion.

18. The amplification device as claimed in claim 14, wherein the liquid medium comprises a counterion dissociated from the ligand.

19. The amplification device as claimed in claim 14, wherein the ligand corresponds to the following chemical formula:

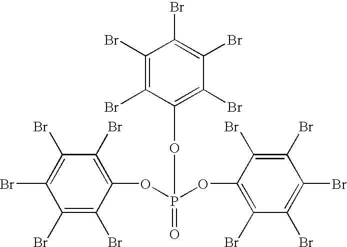

20. The amplification device as claimed in claim 14, wherein the ligand corresponds to the following chemical formula:

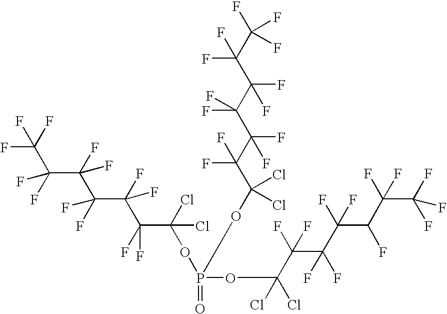

21. The amplification device as claimed in claim 14, wherein the ligand corresponds to the following chemical formula:

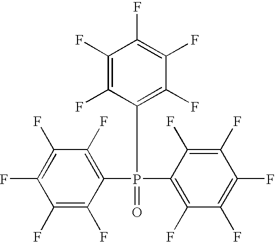

22. The amplification device as claimed in claim 14, wherein the rare earth ion is a lanthanide.

23. The amplification device as claimed in claim 14, wherein the counterion may be of halogen type or of organic type.

24. The amplification device as claimed in claim 14, wherein the complex formed between the ligand and the rare earth ion is of the type:

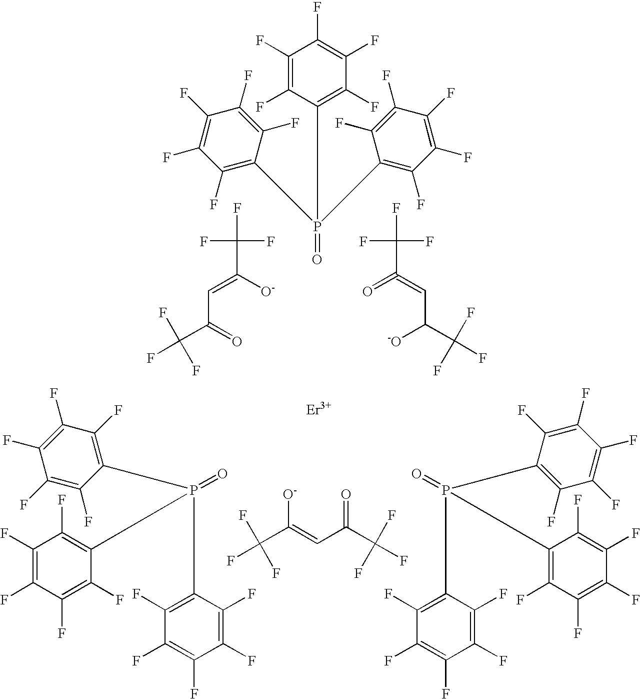

25. The amplification device as claimed in claim 16, wherein the solvent is of halogenated chain type comprising one type of halogen or a variety of halogens.

26. The amplification device as claimed in claim 25, wherein the solvent is a compound of CₙF₂ᵢ₊₂A₂ⱼ₊₂ type, A being a halogen other than fluorine and i+j being equal to n.
